(19) United States
(12) Patent Application Publication
(10) Pub. No.: US 2013/0321805 A1
(43) Pub. Date: Dec. 5, 2013

(54) REAL-TIME TEMPERATURE, OPTICAL BAND GAP, FILM THICKNESS, AND SURFACE ROUGHNESS MEASUREMENT FOR THIN FILMS APPLIED TO TRANSPARENT SUBSTRATES

(71) Applicants: Darryl Barlett, Dexter, MI (US); Barry D. Wissman, Ann Arbor, MI (US); Charles A Taylor, II, Ann Arbor, MI (US)

(72) Inventors: Darryl Barlett, Dexter, MI (US); Barry D. Wissman, Ann Arbor, MI (US); Charles A Taylor, II, Ann Arbor, MI (US)

(73) Assignee: k-Space Associates, Inc., Dexter, MI (US)

(21) Appl. No.: 13/881,194

(22) PCT Filed: Jul. 11, 2011
(86) PCT No.: PCT/US11/43507

§ 371 Date: Aug. 13, 2013

Related U.S. Application Data
(60) Provisional application No. 61/362,938, filed on Jul. 9, 2010.

(51) Int. Cl. G01B 11/30; G01B 11/06

(52) U.S. Cl. CPC G01B 11/303; G01B 11/0625
USPC 356/326

(57) ABSTRACT

A method and apparatus (20) used in connection with the manufacture of thin film semiconductor materials (26) deposited on generally transparent substrates (28), such as photovoltaic cells, for monitoring a property of the thin film (26), such as its temperature, surface roughness, thickness and/or optical absorption properties. A spectral curve (44) derived from diffusely scattered light (34, 34′) emanating from the film (26) reveals a characteristic optical absorption (Urbach) edge. Among other things, the absorption edge is useful to assess relative surface roughness conditions between discrete material samples (22) or different locations within the same material sample (22). By comparing the absorption edge qualities of two or more spectral curves, a qualitative assessment can be made to determine whether the surface roughness of the film (26) may be considered of good or poor quality.

### CROSS REFERENCE TO RELATED APPLICATIONS

This application claims priority to Provisional Patent Application No. 61/362,938 filed Jul. 9, 2010, the entire disclosure of which is hereby incorporated by reference and relied upon.

### BACKGROUND OF THE INVENTION

1. Field of the Invention

The invention relates generally to non-contact measurements of thin film layers applied to a generally transparent substrate; and more particularly for assessing at least the relative surface roughness of the thin film by reference to an optical absorption edge of the thin film material.

2. Related Art

Advanced manufacturing processes involving depositing thin films on substrates often depend on the ability to monitor and control a property of a semiconductor material, such as its temperature, surface roughness, thickness and/or optical absorption properties with high precision and repeatability.

As is now well known, a sudden onset of strong absorption occurs when the photon energy exceeds the band gap energy. In “A New Optical Temperature Measurement Technique for Semiconductor Substrates in Molecular Beam Epitaxy,” Weilmeier et al. (Canadian Journal of Physics, 1991, vol. 69, pp. 422-426) describe a technique for measuring the diffuse reflectivity of a relatively thick substrate having a textured back surface, and inferring the temperature of the semiconductor from the band gap characteristics of the reflected light. The technique is based on a simple principle of solid state physics, namely the practically linear dependence of the interband optical absorption (Urbach) edge on temperature.

Briefly, a sudden onset of strong absorption occurs when the photon energy, hv, nears the band gap energy E_{g}. This is described by an absorption coefficient,

α(hv)=α_{g} exp [(hv−E_{g})/E₀], (Equation 1)

where α_{g} is the optical absorption coefficient at the band gap energy. The absorption edge is characterized by E_{g} and another parameter, E₀, which is the broadening of the edge resulting from the Fermi-Dirac statistical distribution (broadening ˜k_{B}T at the moderate temperatures of interest here). The key quantity of interest, E_{g}, is given by the Einstein model in which the phonons are approximated to have a single characteristic energy, k_{B}. The effect of phonon excitations (thermal vibrations) is to reduce the band gap energy according to:

E_{g}(T)=E_{g}(0)−S_{g}k_{B}θ_{E}/[exp (θ_{E}/T)−1] (Equation 2)

where S_{g} is a temperature independent coupling constant and θ_{E} is the Einstein temperature. In the high T case where θ_{E}<<T, which is well-obeyed for high modulus materials like Si and GaAs, one can approximate the temperature dependence of the band gap by the equation:

E_{g}(T)=E_{g}(0)−S_{g}k_{B}T, (Equation 3)

showing that E_{g} is expected to decrease linearly with temperature T with a slope determined by S_{g} k_{B}. This is well obeyed in practice and is the basis for contemporary absorption edge thermometry, also known as band edge thermometry (BET).

As mentioned above, control of the temperature, surface roughness, thickness and/or optical absorption properties of a semiconductor material, be it the substrate itself or a thin film deposited onto the substrate, can be achieved through non-contact, real-time monitoring of diffusely scattered light emanating from the semiconductor material. The BandiT™ system from k-Space Associates, Inc., Dexter Mich., USA (kSA), assignee of the subject invention, has emerged as a premier, state-of-the-art method and apparatus for measuring temperature, among other properties. Diffusely scattered light from the semiconductor material is detected to measure the optical absorption edge characteristics. From the optical absorption edge characteristics the temperature is accurately determined, as well as other properties such as film thickness. The kSA BandiT can be set up to run in both transmission and reflection modes. In transmission mode, a substrate heater (or other source) may be used as the light source. In reflection mode, the light source is mounted in a non-specular geometry. The kSA BandiT is available in several models covering the spectral range of about 380 nm-1700 nm. Typical sample materials measured and monitored include GaAs, Si, SiC, InP, ZnSe, ZnTe, CdTe, SrTiO₃, and GaN. The kSA BandiT system is described in detail in U.S. Pat. No. 7,837,383, the entire disclosure of which is incorporated here by reference.

One emerging area in which these types of equipment may be applied is the so-called thin-film solar cell. Thin-film solar cells, also known as thin-film photovoltaic (PV) cells, are devices that are made by depositing one or more thin layers (thin films) of photovoltaic material having semiconductor properties on a generally transparent substrate. The thickness range of these thin films varies from a few nanometers to tens of micrometers depending on application. Many different PV materials are deposited with various deposition methods on a variety of substrates. These PV materials may, for example include: Amorphous silicon (a-Si) and other thin-film silicon (TF-Si), Cadmium Telluride (CdTe), Copper indium gallium diselenide (CIS or CIGS), textured poly-silicon, organic solar cells, etc.

The ability to monitor real-time optical band gap properties (that is, optical absorption edge properties) enables manufactured products such as solar panels to achieve consistently high quality and high performance specifications. Although these thin films do, typically, possess semiconductor properties in the aspect of an optical absorption edge, the extremely small thickness of these thin films creates new challenges for the application of existing BET methods and equipment. This is due in part to the increased difficulty of measuring the light absorption properties when transparent and/or non-semiconductor substrate materials are used, because non-semiconductor substrate materials do not have a measurable optical absorption edge and are typically transparent to all practical wavelengths of light. Furthermore, in the field of thin-film PV panel production, manufacturing throughput is increasing so rapidly that thermometry techniques used in the production processes must be compatible with highly automated assembly line conditions. Still further, these types of absorber layers are often very rough and scatter light more substantially than do smooth surfaces. For some applications, an assessment of the surface roughness of a thin film layer may be useful for quality control and manufacturing considerations.

Some in-line film thickness measurement techniques have been proposed for production line thin film PV processes, such as those described in the March/April 2009 issue of Photovoltaics World, Pages 20-25 (www.pvworld.com), the entire disclosure of which is hereby incorporated by reference. However, these prior techniques have been based on certain analytical methods that do not yield consistent or reliable results. In another example, which for the avoidance of doubt is not admitted prior art to the subject application, US Publication No. 2010/0220316 to Finarov discloses a method for thin film PV quality control in which an illuminated line is projected onto the thin film. A detector samples points along the line to derive a spectral signal which is used to compute certain parameters of the thin film.

There is therefore a need in the art to advance and adapt the BET techniques to account for new materials, high throughput production techniques, and increased demands on quality control which are considered necessary to compete in the future markets, including but not limited to PV panel production and other related fields.

### SUMMARY OF THE INVENTION

According to one aspect of the invention, a method is provided for assessing at least the surface roughness of a thin film applied to a generally transparent substrate. A generally transparent substrate is provided. A thin film of material is deposited onto the substrate. The film material composition is of a type that exhibits an optical absorption (Urbach) edge, and has an upper exposed surface with a measurable surface roughness. White light is allowed to interact with the film deposited on the substrate to produce diffusely scattered light. The diffusely scattered light emanating from the film is detected with a detector that is spaced apart from the film, and then routed to a spectrometer to produce spectral data in which the detected light is resolved into discrete wavelength components of corresponding light intensity. An optical absorption (Urbach) edge is then identified in the spectral data. From the characteristics of this absorption edge, an assessment of the relative surface roughness of the film can be made.

The invention is distinguished from prior art techniques in its use of the absorption edge as a metric to assess surface roughness. This approach is more robust and reliable than prior art techniques, and has been determined to yield consistently reliable results particularly in the highly automated, large throughput assembly line conditions.

According to another aspect of this invention, an assembly is provided for assessing the relative surface roughness of a thin film applied to a generally transparent substrate. The assembly comprises: a generally planar substrate fabricated from a non-semiconductor material having no measurable optical absorption edge. In particular, the substrate comprises a glass material composition. A thin film of a material is deposited on the substrate. The thin film has a material composition exhibiting an optical absorption edge, and an upper exposed surface with a discernible surface roughness. A light source is disposed on one side of the thin film for projecting white light toward the thin film. As a result, diffusely scattered light emanates from the thin film. A first detector is spaced apart from the thin film on the same side of the thin film as the light source for detecting the diffusely scattered light reflected from the thin film. A second detector is spaced apart from the thin film on the same side of the thin film as the light source for detecting the diffusely scattered light reflected from the thin film. A third detector is spaced apart from the thin film on the opposite side of the thin film from the light source for detecting the diffusely scattered light transmitted through the thin film. At least one spectrometer is operatively connected to the first, second and third detectors for producing spectral data from the respective detections of diffusely scattered light. A conveyor means moves the thin film and substrate as a unit relative to the detector while maintaining a substantially constant normal spacing therebetween.

### BRIEF DESCRIPTION OF THE DRAWINGS

These and other features and advantages of the present invention will become more readily appreciated when considered in connection with the following detailed description and appended drawings, wherein:

FIG. 1 is a schematic view of an assembly according to this invention wherein a sheet-like substrate and thin film material are conveyed as a unit relative to a BET system including a light source and two diffuse reflection detectors stationed on one side of the sheet and a transmission detector stationed on the opposite side of the sheet;

FIG. 2 is a fragmented perspective and cross sectional view of a film including three layers deposited on a substrate;

FIG. 2A is an enlarged view of a section indicated at 2A in FIG. 2;

FIGS. 3A and 3B are simplified cross-sections through a substrate and thin film showing a beam of light which produces different scattering effects depending on the relative surface roughness of the thin film;

FIG. 4 is a simplified perspective view showing an exemplary optical absorption edge measurement system according to an embodiment of the invention;

FIG. 5 is front elevation view of the embodiment shown in FIG. 4;

FIG. 6 is an enlarged perspective view of the interrogation area of the thin film for the embodiment shown in FIG. 4;

FIG. 7 is an enlarged view of the area where the beam of white light contacts the thin film and showing in relation thereto the alignment axes for two diffuse reflection detectors according to one possible embodiment of the invention;

FIG. 8 is an intensity versus wavelength graph in which are plotted two data spectra, one from the spectrum produced by a relatively smooth thin film surface and the other from the spectrum produced by a relatively rough thin film surface, and depicting one assessment method whereby the integrated area of the curve above the extrapolated absorption edge qualitatively indicates film surface roughness;

FIG. 9 is an intensity versus wavelength graph in which are plotted two spectra, one from the spectrum produced by a relatively smooth thin film surface and the other from the spectrum produced by a relatively rough thin film surface, and depicting another assessment method whereby the relative changes in spectra curves above absorption edge and below absorption edge can be observed to indicate surface roughness;

FIG. 10 is an intensity versus wavelength graph as in FIG. 9 depicting a still further assessment method whereby the slope of the absorption edge can be used to assess surface roughness;

FIG. 11 is a view as in FIG. 4 but showing an alternative scanning methodology whereby the detectors are moved both longitudinally and laterally relative to the film surface;

FIG. 12 is a schematic view of yet another alternative embodiment wherein the data produced by the system can be collected/stored in a database and then transmitted through any suitable technology for remote access; and

FIG. 13 is a front elevation view of another alternative embodiment where the film thickness, absorption edge and surface roughness determinations are all made through a single reflective detector.

### DETAILED DESCRIPTION OF THE PREFERRED EMBODIMENT

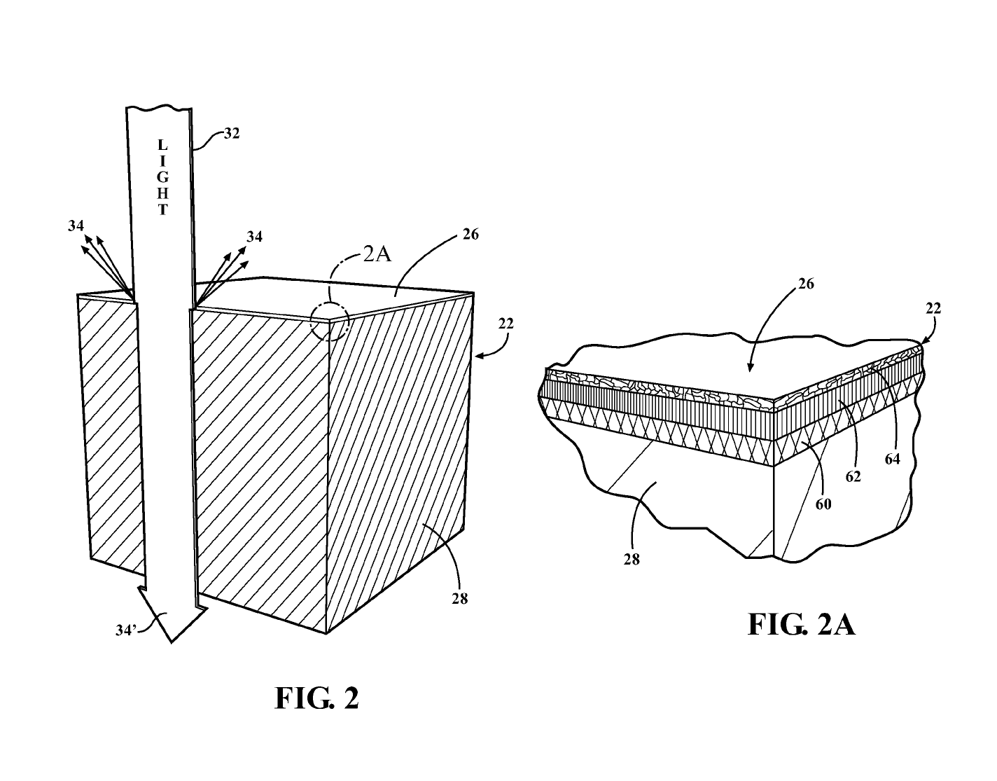

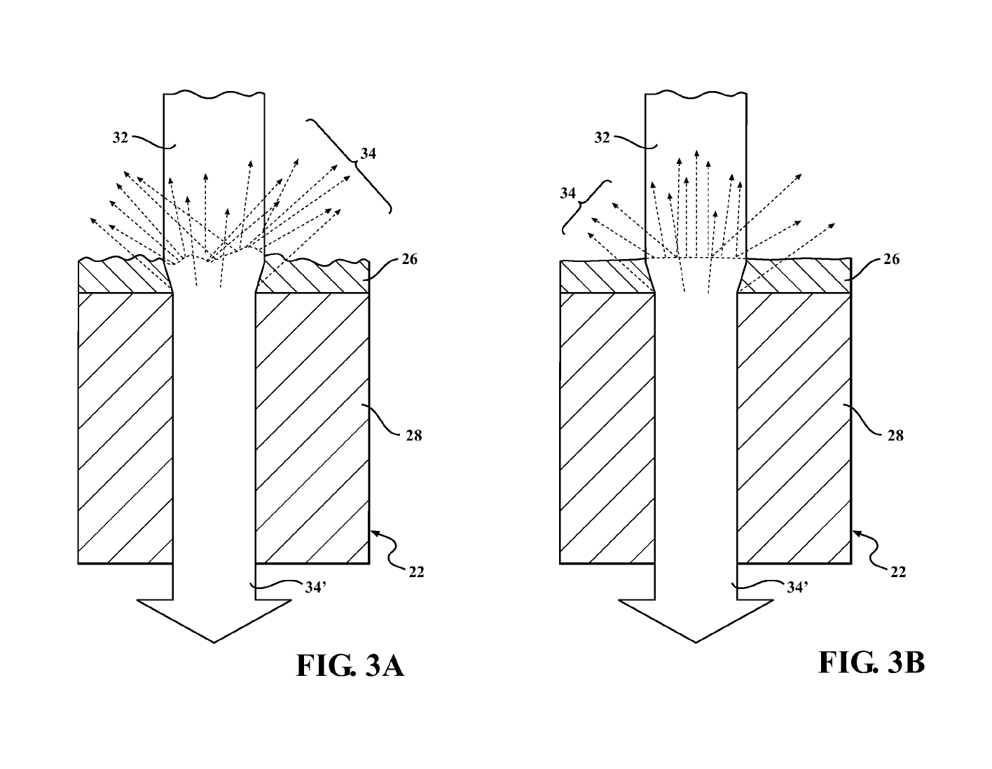

Referring to the figures, wherein like numerals indicate like or corresponding parts throughout the several views, an absorption edge measurement system according to this invention is generally shown at 20. The system 20 is particularly adapted for inline measurement of materials 22 that are moved along a conveyor system 24. Typical materials 22 include the manufacture of PV solar panels on which is applied a thin film absorption layer 26 over a glass (or other suitable) substrate 28. The substrate 28 and thin film 26 layers are shown illustratively in FIGS. 2, 2A, 3A and 3B. It is to be understood that the thin film 26 may, in fact, be composed of multiple discrete layers as shown in FIG. 2A. The thin film composition 26 may be any of the typical materials including, but not limited to, CdTe, CIGS, CdS, textured poly-Si, GaAs, Si, SiC, InP, ZnSe, ZnTe, SrTiO₃, and GaN.

In the specific example of PV panel manufacture, wherein the material 22 comprises a component of a solar panel assembly, it is typical for such materials 22 to comprise rigid sheet-like materials formed to rectangular dimensions and moved as a unit over a conveyor 24 for purposes of absorption edge measurement and/or real time BET measurement techniques using the system 20 of this invention. However, the general principles of this invention are not limited to PV panels, or applications only of sequentially fed sheet materials, but are also applicable to continuous strip applications, disc-like wafers, as well as other conceivable applications. The system 20 includes a light source 30 which may be comparable, generally or specifically, to that described in detail in the applicant's U.S. Pat. No. 7,837,383. The light source 30 produces a beam of white light 32, and in particular non-polarized, incoherent light 32, directed onto the material 22. As shown in FIGS. 2-3B, the beam of light 32 produces scattered and reflected light 34 upon interaction with the thin film 26 and the top surface of the substrate 28. However, because the substrate 28 is largely transparent, a substantial portion of the light beam passes through the material 22 and emerges through the bottom as transmitted light 34′. Both the reflected light 34 and the transmitted light 34′ comprise diffusely scattered light emanating from the thin film 26 as a result of white light 32 interaction with the thin film 26.

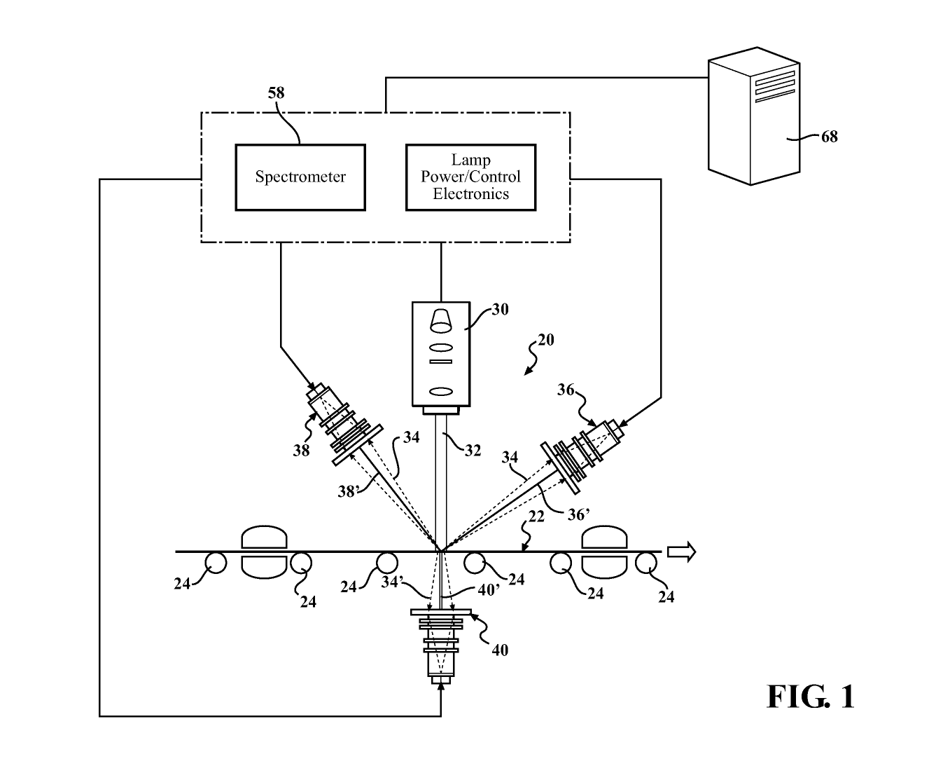

A first absorption edge detector 36 is located in a non-specularly opposed position, i.e., outside the angle of incidence, from the beam 32 so as to collect scattered/reflected light 34. The absorption edge detector 36 is in this arrangement configured as a “reflection mode” detector 36 constructed generally in accordance with that described in U.S. Pat. No. 7,837,383. One or more spectrometers 58 (FIG. 1) may be used which, preferably, are of the solid-state technology type. The spectrometer(s) 58 may be of any suitable type, such as for example a 400-1100 nm, 1024 pixel back thinned Si CCD array system. Of course, alternative spectrometer 58 specifications may be required for different applications.

A second thin film measurement detector, generally indicated at 38, is also disposed at a non-specularly opposed position relative to the light source 30 so as to collect scattered/reflected light 34 from the material 22. Both the first 36 and second 38 detectors are disposed on the same side of the thin film 26 as the light source 30, and thus both configured for reflectance mode operation. The thin film measurement detector 38 is manufactured substantially in accordance with that described in the applicant's co-pending international patent application WO 2010/148385, published Dec. 23, 2010, the entire disclosure of which is hereby incorporated by reference and relied upon.

Both the reflection mode absorption edge detector 36 and thin film measurement detector 38 may be fitted with laser alignment devices as described in U.S. Pat. No. 7,837,383, and configured to produce respective laser beams 36′, 38′ useful in connection with setup to align the detectors 36, 38 relative to the point at which the light beam 32 impacts the material 22. The alignment lasers 36′, 38′ are deactivated during the detection modes.

Further, a third transmission mode detector, generally indicated at 40, is positioned below the material 22 so as to receive transmitted light 34′. The transmission mode detector 40 may include an alignment laser 40′ for use during the initial setup phases of the system.

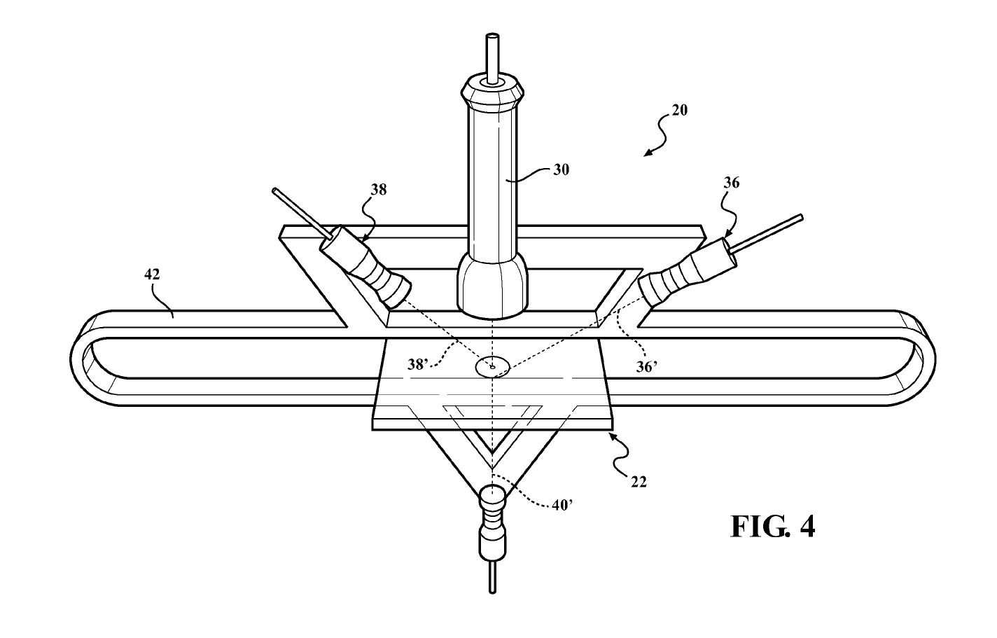

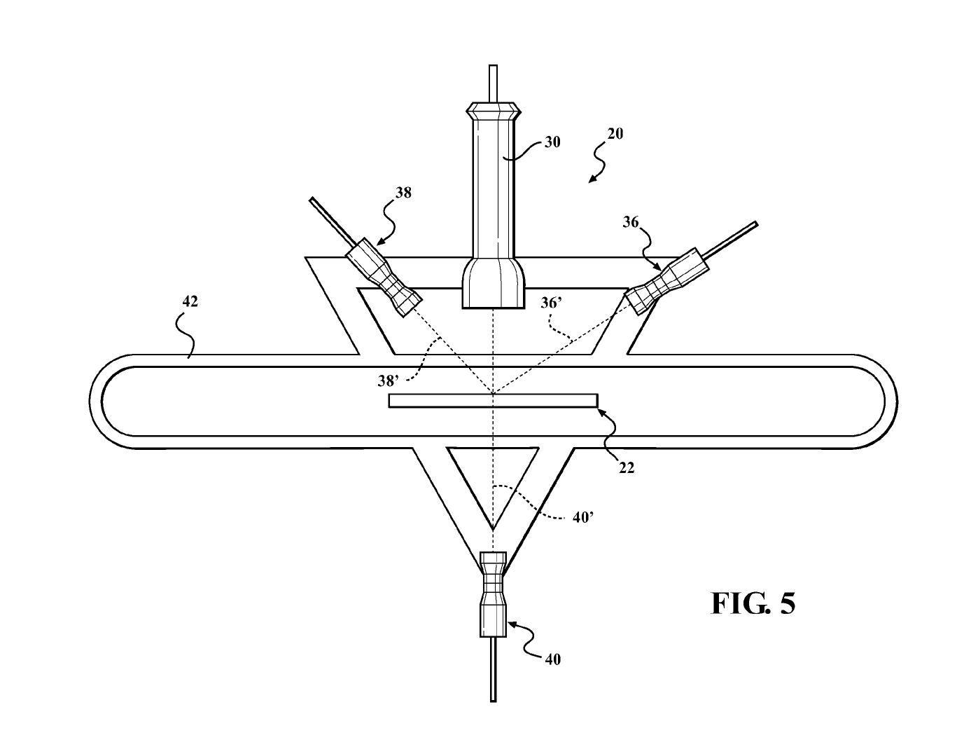

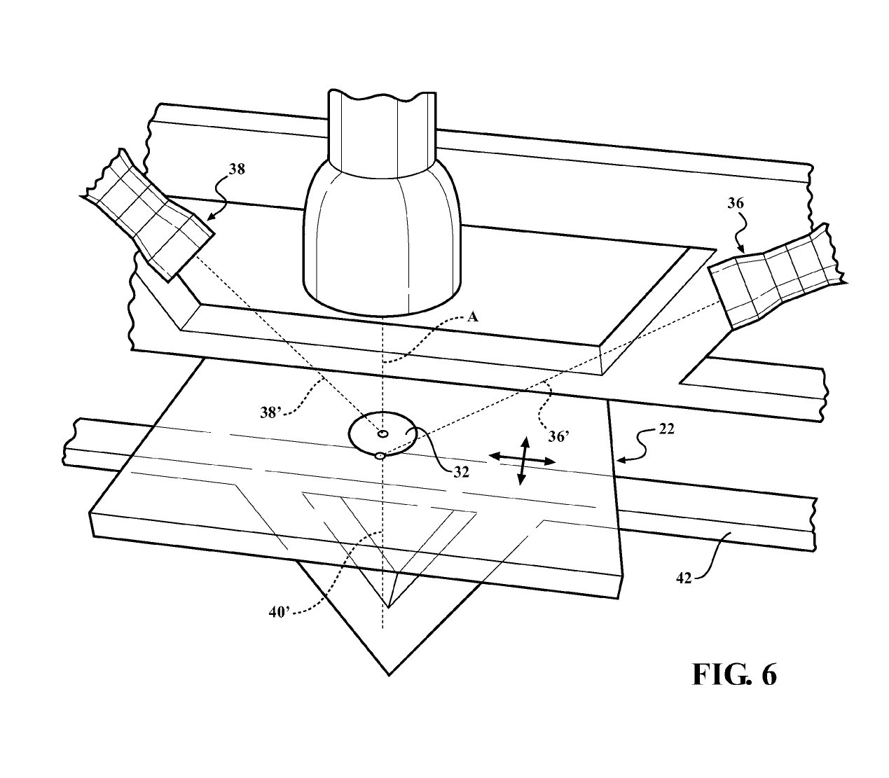

A highly simplified construction for the system 20 is shown in FIGS. 4-6 for illustrative purposes only. In these examples, a common frame structure 42 interconnects the detectors 36, 38, 40 together with the light source 30. Although not shown, it is to be understood that each detector 36, 38, 40 and the light source 30 will be movably mounted to the frame 42 so as to permit individual alignment and adjustment. As suggested earlier, the material 22 is preferably moved linearly relative to the system 20 to provide a continuous, straight-line scan of the absorption edge and temperature along the length of the material 22.

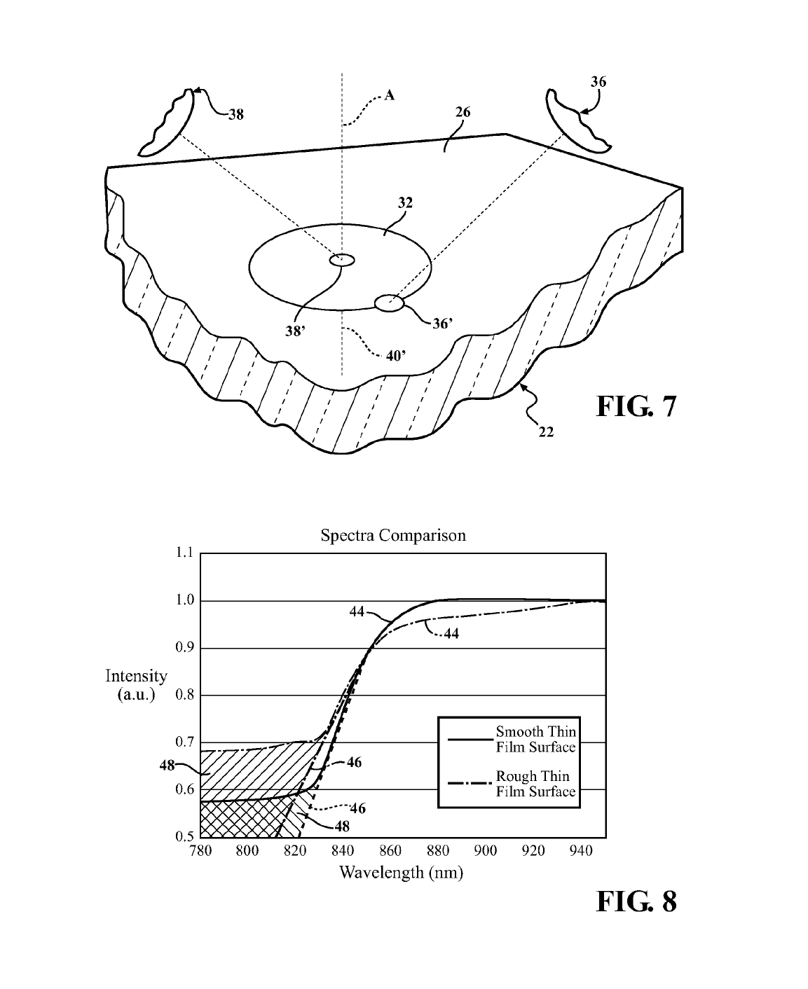

Turning now to FIG. 7, an enlarged view of the material 22 is shown at the point where the light beam 32 from the light source 30 contacts the exposed upper surface of the thin film 26. The centerline of light beam 32 is indicated by letter A. The small circle 38′ which is generally centered along the axis A of light beam 32, represents the point of contact for the alignment laser 38′ emanating from the thin film measurement detector 38. Small circle 36′ from the reflection mode detector 36 may be offset from the centerline A of the light beam 32—in this case shown adjusted partially outside of the beam 32—in situations where the intensity of reflected light 34 has the potential to overpower the detector 36. In situations where the surface roughness of the thin film 26 is high, the intensity of scattered light 34 will be great (as shown in FIG. 3A). In order to prevent over saturation of the reflectance mode absorption edge detector 36, its focus or alignment 36′ can be carefully adjusted to a suitable position which may lie near or just outside the perimeter of the light beam 32. Alternatively the intensity of the light bean 32 can be reduced at the light source 30. Although not clearly shown, the alignment beam 40′ of the transmission mode detector 40 is preferably generally aligned with the centerline A of the light beam 32. However, non-specularly opposed alignment positions of the transmission mode detector 40 may be suitable as well.

In operation, the light source 30 emits radiation for both film thickness determination and diffuse reflectance of the film side and thin film 26 absorption edge detection via transmission mode detector 40. Although not shown, a secondary light source may be located on the underside of the material 22 for use in measuring the absorption edge of any films applied to the bottom edge of the substrate 28, as is the case in some applications. If a secondary light source is used, it may be configured to emit visible radiation for absorption edge detection on any bottom-applied films via diffusive reflection. In the case of a supplemental light source, both light sources will preferably be focused at the same position on the material 22 via a focusing lens as taught in U.S. Pat. No. 7,837,383. Lenses are preferably used as well for the detectors 36, 38, 40 to provide optimal results in terms of total counts, S/N ratio and minimizing stray light collection.

Relative film 26 surface roughness determinations can be made in many ways using the absorption edge derived by the system 20. According to one such technique, spectral data collected from the reflectance mode absorption edge detector 36 are used. Referring to FIG. 8, a sample intensity-wavelength diagram describing processed spectra collected from the system 20 is shown. Curve 44 represents the spectral data collected from the reflectance mode absorption edge detector 36. The linear absorption edge 46 is extended along its slope to intersect the x-axis using a technique described in U.S. Pat. No. 7,837,383 to find the so-called absorption edge wavelength. The area 48 bounded by the region above the linear absorption edge 46 and below the spectral curve 44 is indicative of the intensity of scattered light 34, as shown in FIGS. 3A and 3B. A rougher surface on the thin film 26 will result in more light scattered as compared to a smooth surface, and hence a larger bounded area 48 above the band gap (i.e., above the linear absorption edge 46). Therefore, a qualitative assessment can be made as to surface roughness based on this scatter intensity 34, in that larger areas 48 mean rougher thin film 26 surfaces and vice-versa.

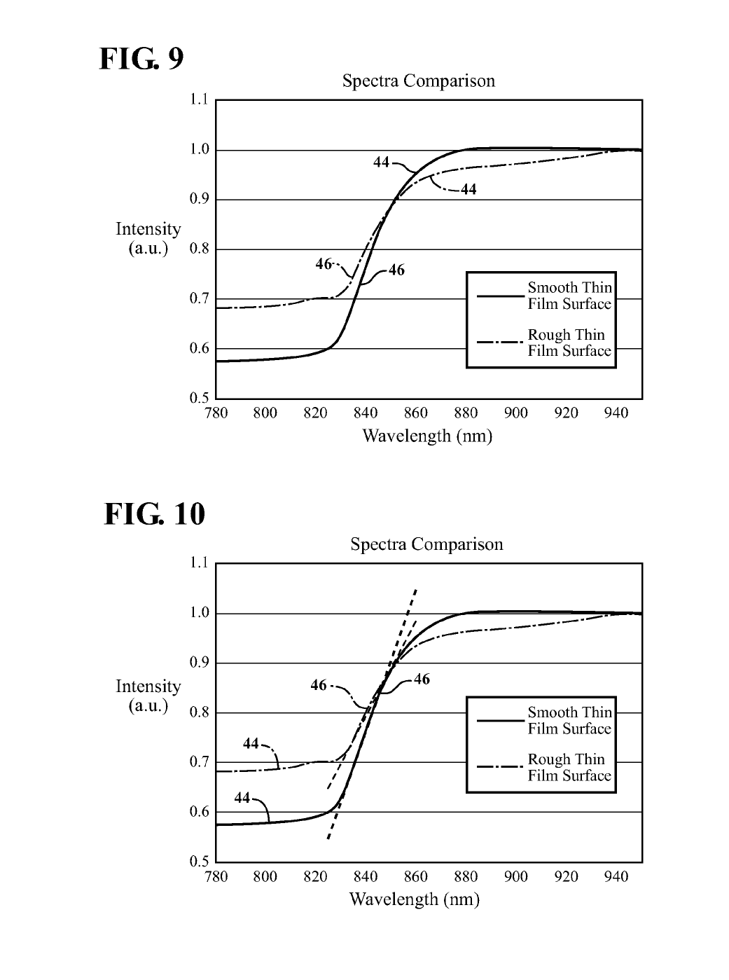

FIG. 9 shows another technique for making a relative surface roughness assessment using the absorption edge identified from the spectral data. For comparison purposes as in FIG. 8, two superimposed data samples are shown—one spectrum representing a relatively smooth surface and the other a relatively rough surface. In this case, it is evident that a spectral curve produced by a relatively rough film surface (i.e., of poor quality) will exhibit greater above-gap intensity than a curve produced by a relatively smooth film surface (i.e., of good quality). It can also be observed that a spectrum produced by a relatively rough film surface will exhibit smaller relative band edge step height than the band edge step height in a curve produced by a relatively smooth film surface. This step height may be understood mathematically as (below gap intensity minus above gap intensity)/below gap intensity. Or said another way: (max−min)/max. Thus FIG. 9 illustrates yet another way in which the absorption edge feature is characteristic of surface roughness and can be used to qualitatively assess one material sample 22 from another sample 22, or different locations in the same material sample 22.

In yet a still further application of the principle that the absorption edge is useful to assess relative surface roughness conditions between discrete materials samples 22 or different locations within the same materials sample 22, FIG. 10 illustrates how the slope of the absorption edge can be used. In this example, as in FIG. 8, again two superimposed data samples are shown representing smooth surface and rough surface films respectively. Here, the slope of the absorption edge for each spectrum is extended on each end to emphasize the fact that a relatively rough film surface will exhibit a smaller absorption edge slope than will the a curve produced by a relatively smooth film surface. Thus, by comparing the slope of spectral curves, a qualitative assessment can be made to determine whether the surface roughness of the film 26 may be considered of good or poor quality.

The first and third detectors 36, 40 may be utilized to monitor the temperature of the film 26, whereas the second detector 38 may be utilized primarily to monitor the thickness of the film 26. In some cases, and in particular when monitoring temperature during the deposition process, it may be desirable to account for changing film thickness. The general dependence of the transmission of light through a semiconductor material is provided by Equation 4 below.

I(d)/I(0)=exp(−αd) (Equation 4)

wherein d is the thickness of the film 26, I(d) is the intensity of the diffusely scattered light collected from the film 26 at the film thickness (d), I(0) is the intensity of diffusely scattered light collected from the substrate 28 without the film 26, and α is the absorption coefficient of the material of the film 26 below the band gap energy of the material. The absorption coefficient of the material (α) accounts for the dependence of the optical absorption on the band gap energy of the material, which is temperature-dependent. The absorption coefficient (α) is also referred to as α(hv) in the equation given above: α(hv)=α_{g} exp [(hv−E_{g})/E₀] (Equation 1).

Equation 1 illustrates that the optical absorption of the film 26 is thickness-dependent and the behavior of the optical absorption is exponential. In applications wherein the substrate 28 has no measurable optical absorption edge wavelength, light 32 diffusely scatters from the surfaces of the thin film 26, the interface between the film 26 and the thick substrate 28, and the surfaces of the substrate 28, like substrates formed of semiconductor materials. For substrates 28 formed of semiconductor materials, the light 32 is affected by the substrate 28, which has a large thickness, so the incremental changes in the thickness have virtually no significant effect on the optical absorption edge. However, when the substrate 28 is formed of a material having no measurable optical absorption edge wavelength, such as a non-semiconductor, the light 32 is essentially not affected by the substrate 28. The substrate 28 in these situations is typically either transparent (e.g. glass or sapphire) or completely reflective (e.g. steel or other metal). Thus, the light 32 is only affected by the semiconductor film 26. Since the film 26 is thin, the incremental increases or changes in the film thickness will have a significant effect on the measured optical absorption edge wavelength of the film 26. An incremental change or increase in the film thickness is typically a 1.0 μm increase or decrease in thickness.

In one exemplary embodiment shown in FIG. 2A, the film 26 includes three layers 60, 62, 64 deposited on a substrate 28 of sapphire. The substrate 28 has a thickness of about 600 μm. The base layer 60 disposed on the substrate 28 includes undoped GaN and includes a thickness of about 3.0 μm to about 4.0 μm. The middle layer 62 deposited on the base layer 60 is doped GaN and includes a thickness of about 0.5 μm to about 1.0 μm. The top layer 64 deposited on the middle layer 62 is InGaN and includes a thickness of about 0.2 μm to about 0.5 μm. The temperature of the top layer 64 while it is being deposited on the substrate 28 and during processing may be especially crucial to the quality of the resulting product. As alluded to above and shown in FIGS. 3A and 3B, the light diffusely scatters from the top and bottom surfaces of each of the layers 60, 62, 64 of the film 26.

The method, apparatus, and system of the present invention can be configured to account for the incremental changes in the thickness of the film 26 by determining the optical absorption edge wavelength of the film 26 as a function of the film thickness, which is then used to determine the temperature of the film 26. The optical absorption edge wavelength and temperature are determined at a time during the manufacturing process when adjustments can be made to the film 26 to correct undesirable temperatures which yield undesirable properties.

The first step includes performing spectra acquisition to correct potential errors due to equipment artifacts, such as a non-uniform response of the detector used and non-uniform output light signals. These errors could prevent raw diffuse reflectance light signals from yielding a measurable optical absorption edge at the correct wavelength position. When performing the spectra acquisition, it can be assumed the errors are steady-state.

The spectra acquisition first includes producing a reference spectrum representing the overall response of the system, i.e. the combination of light source output signature and detector response, which are both wavelength dependent. The reference spectrum is produced by illuminating the substrate 28 with light, without the film 26, for example bare sapphire, and collecting diffusely scattered light in the detector 40. Next, the spectrometer 58 is used to generate the reference spectrum based on the diffusely scattered light collected from interacting light with the substrate 28 alone. The spectra acquisition concludes by normalizing the reference spectrum.

Each time a raw spectrum is produced based on the diffusely scattered light from the film, the method includes normalizing the raw spectrum, and dividing the normalized raw spectrum, by the normalized reference spectrum to produce a resultant spectrum. Dividing the raw spectrum by the reference spectrum is performed on every incoming raw spectrum, and is necessary to determine an accurate film thickness, in addition to enhancing the optical absorption edge signature. The resultant spectrum is normalized and used to determine the optical absorption edge wavelength. The resultant spectrum provides a resolvable optical absorption edge wavelength, which is used to determine the temperature or another property of the film 26.

The spectra acquisition, including creating a normalized reference spectrum, is performed each time a component of the system changes. For example, a view port of the detector 40 can become coated over time, which affects the collected light. The spectral acquisition can be performed one time per run, one time per day, one time per week, or at other time intervals, as needed. Performing the reference spectrum acquisition one time per run will typically provide more accurate results than once per week.

The spectrum of the present method and system, including the reference spectrum, raw spectrum, and the resultant spectrum, are typically produced by resolving the light signals from the substrate 28 into discrete wavelength components of particular light intensity. The spectrum indicates the optical absorption of the film 26 based on the diffusely scattered light from the film 26. The spectrum typically includes a plot of the intensity versus wavelength of the light, as shown in FIGS. 7-9. However, the spectrum can provide the optical absorption information in another form, such as a table.

The resultant spectra are used to determine the optical absorption edge wavelength. As discussed supra, the optical absorption edge wavelength is the abrupt increase in degree of absorption of electromagnetic radiation of a material at a particular wavelength. The optical absorption edge wavelength is dependent on the specific material, the temperature of the material, and the thickness of the material. The optical absorption edge wavelength can be identified from the spectra; it is the wavelength at which the intensity sharply transitions from very low (strongly absorbing) to very high (strongly transmitting). The optical absorption edge wavelength is used to determine the temperature of the substrate 28, as well as to make the relative surface roughness assessments described above.

The method may further include producing a temperature versus wavelength calibration table (temperature calibration table) of the film 26 at a single thickness. The temperature calibration table can also be provided to a user of the method, rather than produced by the user of the method. The temperature calibration table indicates the temperature versus optical absorption edge wavelength at a constant thickness of the film. The temperature calibration table provides subsequent temperature measurements of the film based on the optical absorption edge wavelength obtained from the spectra. However, unlike in the prior art system and method, the present system and method further includes determining the temperature of the film 26 by accounting for the effect of the thickness of the film 26 on the optical absorption edge wavelength, or the dependence of the optical absorption edge wavelength on film thickness, which will be discussed further below.

As stated above, the method and system of the present invention includes determining the optical absorption edge of the film 26, which may optionally be determined as a function of the film 26 thickness if under the circumstances it is relevant that the optical absorption edge wavelength of the film 26 depends on the thickness of the film 26. The film thickness has an especially significant impact on the optical absorption edge of thin films 26, and thus the determination of the temperature of the thin films 26, such as the top layer 64 of the sample of FIG. 2A.

The thickness of the film 26 can be determined by a variety of methods. In one embodiment of the invention, the thickness of the film 26 is conveniently determined from the spectrum produced by the light diffusely scattered from the film 26 and used to determine the optical absorption edge wavelength, discussed above. The spectrum, often includes oscillations below (to the right of) the optical absorption edge region of the spectrum. The oscillations are a result of thin film interference, which is similar to interference rings sometimes observable on a thin film of oil. A derivative analysis of the wavelength-dependent peaks and valleys of the oscillations is employed to determine the thickness of the film 26. Equation 5 below can be employed to determine the thickness of the film 26,

$$d = \frac{1}{2 ( {n}_{1} / {λ}_{1} - {n}_{2} / {λ}_{2} )} \qquad ( Equation 5 )$$

wherein d is the thickness of the film, λ₁ is the wavelength at a first peak of the oscillations and λ₂ is the wavelength at a second peak of the oscillations adjacent the first peak, or alternatively λ₁ is the wavelength at a first valley of the oscillations and λ₂ is the wavelength at a second valley of the oscillations adjacent the first valley, n₁ is a predetermined index of refraction dependent on the material of semiconductor at λ₁, and n₂ is a predetermined index of refraction dependent on the material of semiconductor at λ₂. The wavelengths used for λ₁ and λ₂ can be any two successive peaks or any two successive valleys of the oscillations. The oscillations and value obtained for thickness of the film 26 have a non-linear dependence on all layers 60, 62, 64 of the film 26. The thickness of the film 26 can also be determined using other methods. For example, the thickness can be estimated based on previous measurements of thickness as a function of deposition time or by laser-based reflectivity systems such as the Rate Rat™ product available from k-Space Associates, Inc., Dexter, Mich. USA.

As stated above, the step of determining the optical absorption edge of the film 26 as a function of the film 26 thickness includes accounting for the dependence of the optical absorption of the film 26 on the film thickness. The step of determining the optical absorption edge of the film 26 as a function of the film thickness can also include adjusting a measured optical absorption edge wavelength value of the film 26 obtained from the spectra due to the step of depositing the film 26 of a semiconductor material having a measurable optical absorption edge and a measurable thickness on the substrate 28. The step of determining the optical absorption edge of the film 26 as a function of the film thickness can also include identifying the semiconductor material of the film 26 and adjusting a measured optical absorption edge wavelength value determined from the spectra based on the semiconductor material and the thickness of the film 26 to obtain an adjusted absorption edge wavelength.

The step of determining the optical absorption edge of the film 26 as a function of the film thickness typically includes using a thickness calibration table. Each semiconductor material has a unique thickness calibration table. The thickness calibration table indicates optical absorption edge wavelength versus thickness at a constant temperature of the film.

The thickness calibration table can be acquired by growing a film 26 of the semiconductor material at a constant temperature and measuring the optical absorption edge wavelength at each incremental increase in thickness to produce a spectrum for each thickness. The thickness calibration table can also be prepared by depositing the film 26 on the substrate 28 at a constant temperature and measuring the optical absorption edge wavelength of the film 26 at the constant temperature and a plurality of thicknesses. Preparing the thickness calibration table at a constant temperature also allows a user to determine the dependence of the optical absorption edge wavelength on the thickness.

The spectra acquisition is performed on each spectrum, as described above. Next, from each spectrum a raw optical absorption edge wavelength value is determined for each thickness at the constant temperature. An n^{th} order polynomial fit is performed on the raw optical absorption edge wavelength values to produce the optical absorption edge wavelength versus thickness curve, where n is the order of the polynomial providing the best fit to the data. This nth order polynomial dependence is used to create the thickness calibration table. The thickness calibration table is used as a thickness correction lookup up for subsequent temperature measurements. The thickness calibration table illustrates the dependence of the optical absorption edge wavelength on film thickness. The optical absorption edge wavelength increases as the film thickness increases. The thickness calibration table is produced for each unique semiconductor material, as different materials produce different results. The thickness calibration table can also be provided to a user of the method, rather than produced by the user. However, for each unique material, only one thickness calibration table is needed to determine temperature of the film at various thicknesses and temperatures. The method can include identifying the semiconductor material of the film and providing the thickness calibration table and temperature calibration table for the identified semiconductor material. The temperature of the film at a certain thickness is determined based on the spectrum, the thickness calibration table, and the temperature calibration table.

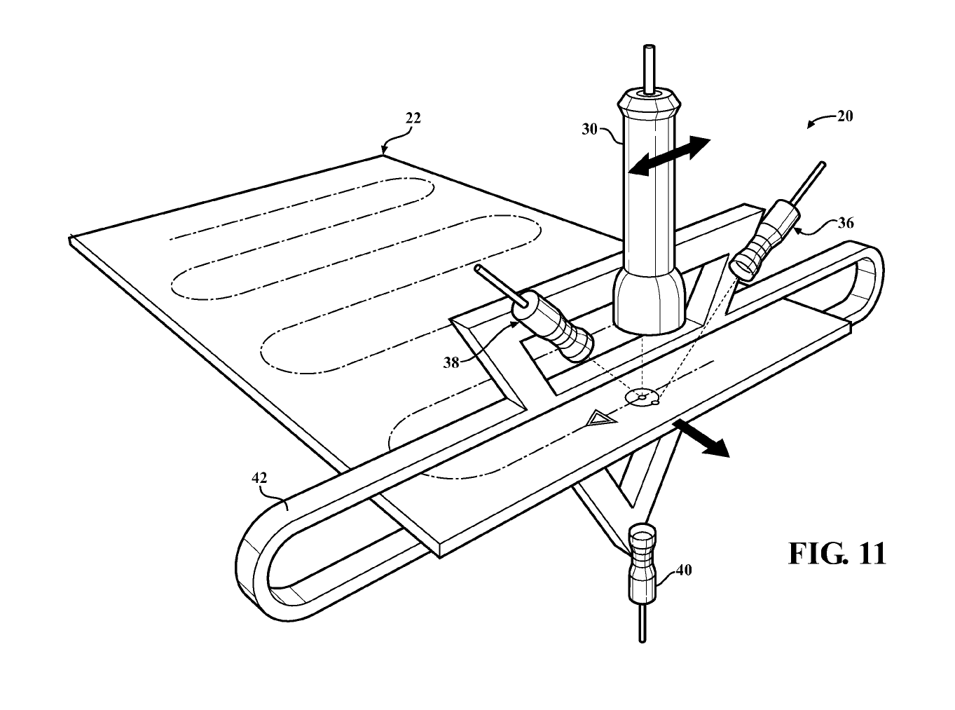

In alternative constructions, it may be desirable to move the system 20 relative to the material 22. Such relative movements may include relative lateral as well as longitudinal directions, or even curvilinear motions, so as to scan either sequentially or intermittently different surface locations of the material 22. As shown in FIG. 11, this can be automated to scan the entire sheet of material 22. Different control/material handling strategies can result in a variety of scan path geometries.

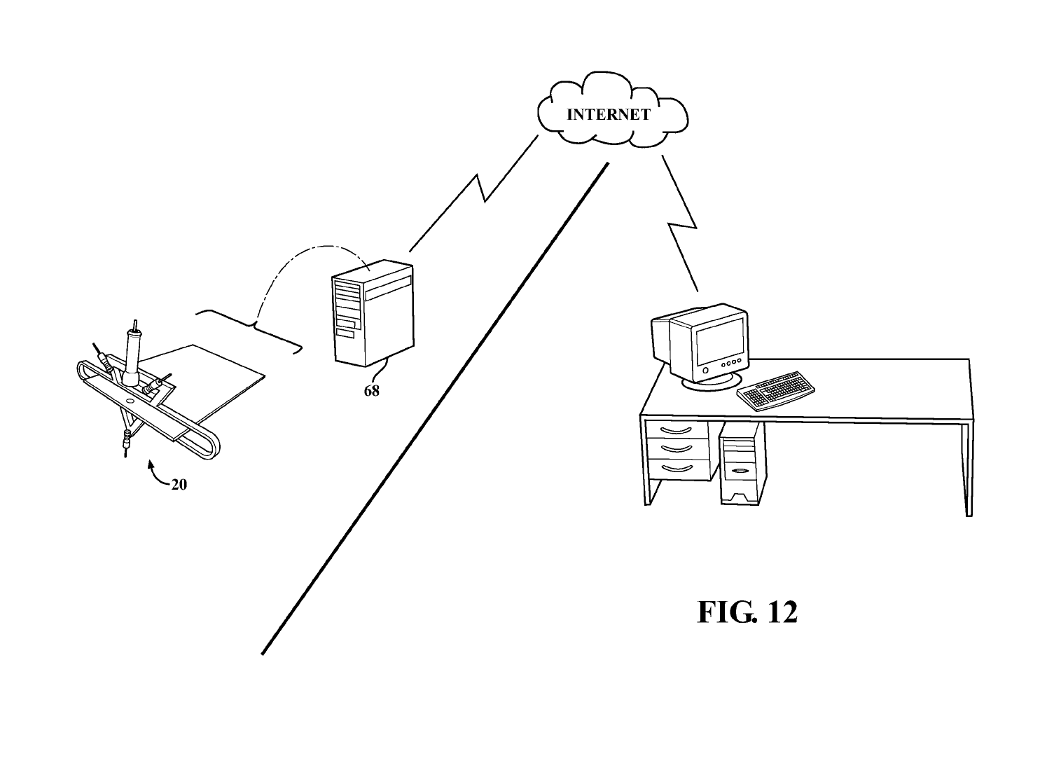

Transmission mode detector 40 may incorporate an optical trigger mechanism capable of sensing the presence or absence of material 22 crossing the beam 32. Alternatively, a stand-alone or other type of optical trigger can be used to accomplish a similar purpose. This data can be used for quality control and material 22 tracking purposes. As shown in FIG. 12, the data produced by the system 20 can be collected/stored in a database 68 and then transmitted through any suitable technology for remote access. In this way, real-time monitoring of the parameters measured by the system 20 can be available to any interested parties whether or not they are physically located at the manufacturing site.

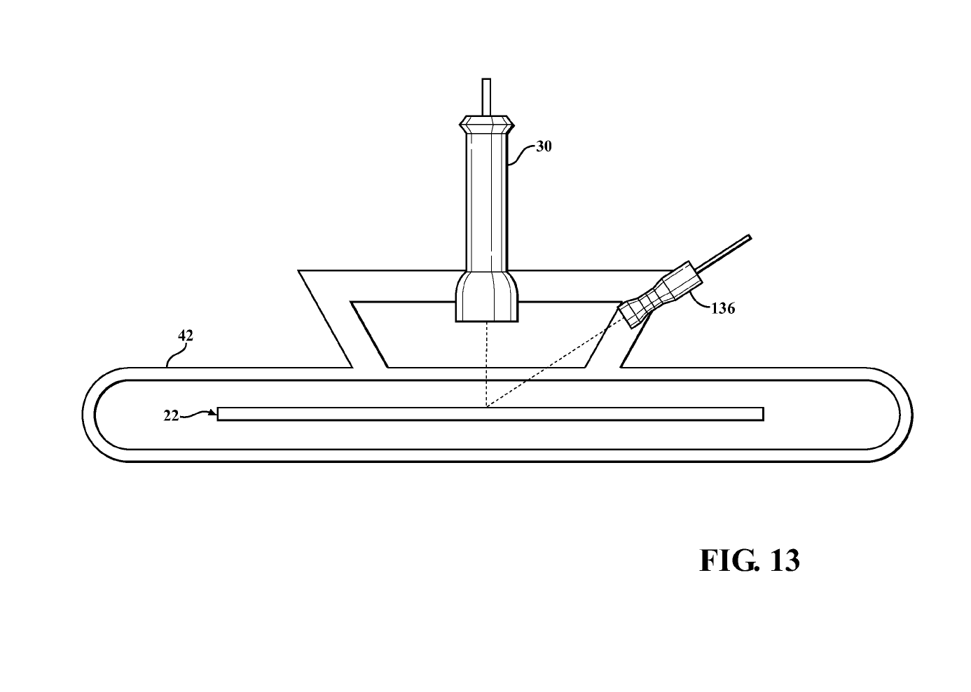

The functionality of the three detectors 36, 38, 40 described above can be consolidated into one single detector 136 as shown in FIG. 13. Of course, many other configurations and variations of the general concepts of this invention are possible and will become apparent to those of skill in the art.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A method for assessing at least the surface roughness of a thin film applied to a generally transparent substrate, said method comprising the steps of:
a) providing a generally transparent substrate;
b) depositing a thin film of material onto the substrate; the film material composition exhibiting an optical absorption (Urbach) edge; the film having an upper exposed surface with a measurable surface roughness;
c) interacting white light with the film deposited on the substrate to produce diffusely scattered light;
d) detecting the diffusely scattered light emanating from the film with a detector spaced apart from the film;
e) collecting the detected light in a spectrometer; using the spectrometer to produce spectral data in which the detected light is resolved into discrete wavelength components of corresponding light intensity;
f) identifying the optical absorption (Urbach) edge in the spectral data; and
g) determining a relative surface roughness of the film as a function of the absorption edge.

2. The method of claim 1 wherein said step of determining the surface roughness includes computing the area under the intensity versus wavelength spectrum, above the identified absorption edge.

3. The method of claim 1 wherein said step of determining the surface roughness includes comparing the relative change in the spectral data both above and below the absorption edge.

4. The method of claim 1 wherein said step of determining the surface roughness includes comparing the slope of the absorption edge to a reference absorption edge slope.

5. The method of claim 1 wherein said step of determining the surface roughness includes comparing at least two absorption edges acquired from different sets of spectral data.

6. The method of claim 1 further including the step of scanning the exposed surface of the thin film with the detector.

7. The method of claim 6 wherein said scanning step includes moving the thin film and substrate as a unit relative to the detector while maintaining a substantially constant normal spacing therebetween.

8. The method of claim 7 wherein said moving step includes translating the thin film and substrate as a unit in combined lateral and longitudinal directions relative to the detector.

9. The method of claim 1 wherein the substrate comprises a glass material composition.

10. The method of claim 1 wherein said depositing step includes condensing a vaporized form of the film material onto the substrate within a vacuum chamber prior to said interacting step.

11. The method of claim 1 wherein said interacting step includes reflecting light off the exposed surface of the thin film.

12. The method of claim 1 wherein said interacting step includes transmitting light through the thin film and the substrate.

13. The method of claim 1 wherein the spectrometer comprises a solid state spectrometer.

14. The method of claim 1 further including the step of determining a thickness of the film as a function of the identified absorption edge.

15. A method for collectively determining the optical absorption edge, surface roughness and thickness of a thin film applied to a generally transparent substrate, said method comprising the steps of:
a) providing a substrate of material having no measurable optical absorption edge; the substrate comprising a glass material composition;
b) depositing a thin film of a semiconductor material onto the substrate; the film material composition exhibiting an optical absorption (Urbach) edge; the film having an upper exposed surface with a measurable surface roughness; said depositing step including condensing a vaporized form of the film material onto the substrate within a vacuum chamber;
c) interacting non-polarized, non-coherent white light with the film deposited on the substrate to produce diffusely scattered light; said interacting step including at least one of reflecting light off the exposed surface of the thin film and transmitting light through the thin film and substrate;
d) detecting the diffusely scattered light emanating from the film with a detector spaced apart from and in non-contacting relationship with the thin film;
e) collecting the detected light in a spectrometer; using the spectrometer to produce spectral data in which the detected light is resolved into discrete wavelength components of corresponding light intensity;
f) identifying the interband optical absorption (Urbach) edge in the spectral data;
g) determining a relative surface roughness of the film as a function of the absorption edge; said step of determining the surface roughness including at least one of: computing the area under the intensity versus wavelength spectrum, above the identified absorption edge, comparing the relative change in the spectral data both above and below the absorption edge, and comparing the slope of the absorption edge to a reference absorption edge slope;
h) determining a thickness of the film as a function of the identified absorption edge.

16. An assembly for assessing the relative surface roughness of a thin film applied to a generally transparent substrate, said assembly comprising:
a) a generally planar substrate; said substrate being fabricated from a non-semiconductor material having no measurable optical absorption edge; the substrate comprising a glass material composition;
b) a thin film of a semiconductor material deposited on said substrate; said thin film having a material composition exhibiting an optical absorption (Urbach) edge; said thin film having an upper exposed surface with a measurable surface roughness;
c) a light source disposed on one side of said thin film for projecting white light toward said thin film and producing diffusely scattered light emanating therefrom;
d) a first detector spaced apart from said thin film on the same side of said thin film as said light source for detecting the diffusely scattered light reflected from said thin film;
e) a second detector spaced apart from said thin film on the same side of said thin film as said light source for detecting the diffusely scattered light reflected from said thin film;
f) a third detector spaced apart from said thin film on the opposite side of said thin film from said light source for detecting the diffusely scattered light transmitted through said thin film;
g) at least one spectrometer operatively connected to said first, second and third detectors for producing spectral data from the respective detections of diffusely scattered light; and
h) conveyor means for moving the thin film and substrate as a unit relative to the detector while maintaining a substantially constant normal spacing therebetween.
